(19) United States
(12) Patent Application Publication
(10) Pub. No.: US 2022/0230023 A1
(43) Pub. Date: Jul. 21, 2022

(54) ANOMALY DETECTION METHOD, STORAGE MEDIUM, AND ANOMALY DETECTION DEVICE

(71) Applicant: FUJITSU LIMITED, Kawasaki-shi (JP)

(72) Inventor: Kenichiroh Narita, Kawasaki (JP)

(73) Assignee: FUJITSU LIMITED, Kawasaki-shi (JP)

(21) Appl. No.: 17/713,452

(22) Filed: Apr. 5, 2022

Related U.S. Application Data
(63) Continuation of application No. PCT/JP2019/041757, filed on Oct. 24, 2019.

(51) Int. Cl. G06K 9/62; G06F 17/18; G06F 17/15

(52) U.S. Cl. CPC G06K 9/6217; G06F 17/15; G06F 17/18

(57) ABSTRACT

An anomaly detection method for a computer to execute a process includes obtaining a plurality of waveform data detected by a plurality of sensors arranged on a monitoring target; specifying a plurality of target waveform data from among the plurality of waveform data based on a correlation of a shape of the obtained plurality of waveform data; combining the plurality of target waveform data into combined waveform data; clustering the combined waveform data by dividing into clusters for a time unit; and detecting an anomaly of the monitoring target based on a size of each of the clusters.

### CROSS-REFERENCE TO RELATED APPLICATION

This application is a continuation application of International Application PCT/JP2019/041757 filed on Oct. 24, 2019 and designated the U.S., the entire contents of which are incorporated herein by reference.

### FIELD

The embodiments discussed herein are related to an anomaly detection method, a storage medium, and an anomaly detection device.

### BACKGROUND

With the development of Internet of Things (IoT) technology, utilization of sensor data has been promoted. For example, in a case of detecting an anomaly from waveform data of a sensor disposed on a monitoring target, data analysis is carried out using a statistical method such as autocorrelation, a histogram, a fast Fourier transform (FFT) analysis, or an autoregressive analysis.

Japanese Laid-open Patent Publication No. 2019-105592 is disclosed as related art.

### SUMMARY

According to an aspect of the embodiments, an anomaly detection method for a computer to execute a process includes obtaining a plurality of waveform data detected by a plurality of sensors arranged on a monitoring target; specifying a plurality of target waveform data from among the plurality of waveform data based on a correlation of a shape of the obtained plurality of waveform data; combining the plurality of target waveform data into combined waveform data; clustering the combined waveform data by dividing into clusters for a time unit; and detecting an anomaly of the monitoring target based on a size of each of the clusters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of a system according to a first embodiment;

FIG. 2 is a diagram illustrating exemplary waveform data of a sensor;

FIG. 3A is a diagram illustrating exemplary waveform data of sensors;

FIG. 3B is a diagram illustrating exemplary waveform data of the sensors;

FIG. 4A is a schematic diagram illustrating exemplary waveform data after regularization;

FIG. 4B is a schematic diagram illustrating exemplary waveform data of a difference;

FIG. 5 is a diagram illustrating an exemplary heat map of regular values;

FIG. 6 is a diagram illustrating an exemplary clustering result;

FIG. 7 is a block diagram illustrating a functional configuration of an anomaly detection device according to the first embodiment;

FIG. 8 is a diagram illustrating an exemplary analysis request screen;

FIG. 9 is a diagram illustrating exemplary waveform data of sensors;

FIG. 10 is a diagram illustrating an exemplary map of correlation coefficients;

FIG. 11 is a diagram illustrating exemplary waveform data to be analyzed;

FIG. 12 is a diagram illustrating an exemplary clustering result;

FIG. 13 is a diagram illustrating an exemplary alert screen;

FIG. 14 is an enlarged view of a display area;

FIG. 15 is an enlarged view of the display area;

FIG. 16 is a flowchart illustrating a procedure of an anomaly detection process according to the first embodiment; and

FIG. 17 is a diagram illustrating an exemplary hardware configuration of a computer.

### DESCRIPTION OF EMBODIMENTS

Even when the waveform data of the sensor is analyzed using the statistical method mentioned above, an anomaly point for the monitoring target does not necessarily appear as a statistical singular point, whereby the accuracy in anomaly detection may be deteriorated at times.

In one aspect, the embodiments aim to provide an anomaly detection method, an anomaly detection program, and an anomaly detection device capable of suppressing a decrease in anomaly detection accuracy.

Hereinafter, an anomaly detection method, an anomaly detection program, and an anomaly detection device according to the present application will be described with reference to the accompanying drawings. Note that the embodiments do not limit the technology disclosed. Then, each of the embodiments may be suitably combined within a range without causing contradiction between processing contents.

### First Embodiment

### 1. Exemplary System Configuration

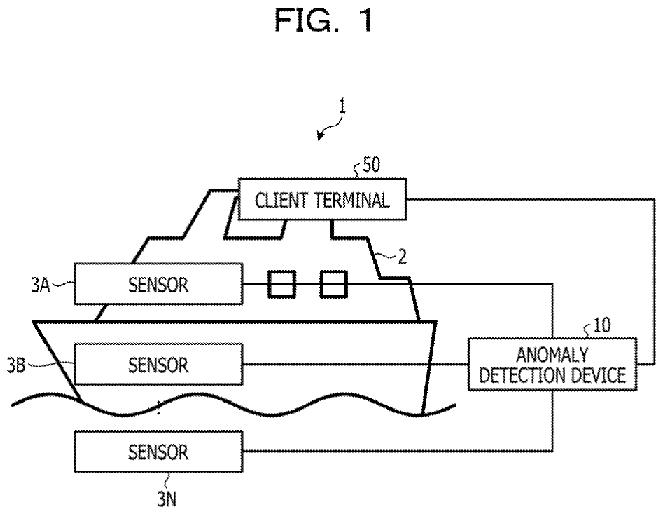

FIG. 1 is a diagram illustrating an exemplary configuration of a system 1 according to a first embodiment. The system 1 illustrated in FIG. 1 provides an anomaly detection service for detecting an anomaly in a monitoring target 2 from waveform data of sensors 3A to 3N disposed on the monitoring target 2. While a ship is exemplified as merely an example of the monitoring target 2 to which such an anomaly detection service is applied, the monitoring target 2 is not limited to the ship. For example, the monitoring target 2 may also be a mobile object other than a ship, which is, for example, a person, a vehicle, or the like. Furthermore, the monitoring target 2 is not necessarily a mobile object, and may be any facility or device other than the mobile object.

As illustrated in FIG. 1, the system 1 may include the sensors 3A to 3N, an anomaly detection device 10, and a client terminal 50. Hereinafter, the sensors 3A to 3N may be referred to as a “sensor 3” in a case where the individual sensors 3A to 3N do not need to be distinguished.

The sensor 3 is arranged on the monitoring target 2. The “arrangement” referred to here may include a form incorporated inside the monitoring target 2 and a form externally attached to the monitoring target 2.

The following types of the sensor 3 may be mounted on the ship serving as the monitoring target 2. For example, sensors of a vessel speed, true wind direction, true wind speed, main engine (M/E) fuel integration, main engine rotation speed, fuel integration, shaft horsepower, shaft rotation speed, controllable pitch propeller (CPP) blade angle response value, rudder angle response value, bow thruster (B/T) blade angle response value, stern thruster (S/T) rotation speed, and the like may be applicable as the sensor 3. Furthermore, the sensor 3 may include sensors of an M/E fuel instantaneous value, fuel instant, bow orientation, latitude, longitude, global positioning system (GPS) altitude, GPS moving direction, GPS moving speed, and the like. Moreover, the sensor 3 may include sensors of a roll angle, pitch angle, yaw angle, front-rear acceleration level, right-left acceleration level, up-down acceleration level, roll angular speed, pitch angular speed, and the like.

Note that the sensor 3 and the anomaly detection device 10 may be connected by any communication network regardless of whether they are connected by wire or wirelessly. For example, sensor data transmitted from the sensor 3 to the anomaly detection device 10 may be transferred as a message queuing telemetry transport (MQTT) message. At this time, a measured value may also be transmitted in real time each time the measured value is obtained, or may be transmitted as time-series data of measured values after being accumulated over a predetermined period of time, which is, for example, 1 minute, 1 hour, 12 hours, 1 day, 1 week, 1 month, or the like.

The anomaly detection device 10 corresponds to an example of a computer that provides the anomaly detection service described above.

As one embodiment, the anomaly detection device 10 may be mounted as package software or online software by installing an anomaly detection program implementing a function corresponding to the anomaly detection service described above on any computer. For example, the anomaly detection device 10 is not necessarily mounted on the monitoring target 2, and may be mounted as a computer on a network. As merely an example, the anomaly detection device 10 may provide the anomaly detection service described above as an IoT platform or a cloud service packaged with a back-end service. At this time, it is also permissible if the IoT platform and the anomaly detection service described above are provided by different vendors. In addition, the anomaly detection device 10 may also be mounted as an on-premise server that provides functions related to the anomaly detection service described above.

The client terminal 50 corresponds to an example of a computer provided with the anomaly detection service described above.

Such a client terminal 50 may be any computer that may be mounted on the monitoring target 2, and may not necessarily be a general-purpose computer but may be a unit or the like that controls steering or an engine of a ship. In addition, the client terminal 50 may be a computer to be used by a person involved in the monitoring target 2. In this case, the client terminal 50 may be any computer such as a mobile terminal device or a wearable terminal, and its location may be a distant place away from the monitoring target 2.

Note that, while the client terminal 50 is exemplified as an example of the output destination for anomaly detection in FIG. 1, the output destination is not necessarily a computer. For example, the output destination for the anomaly detection may be a general output device of an audio output device or a print output device, as well as a display device such as a light emitting diode (LED) or a liquid crystal display.

[2.1 Anomaly Detection Using Single Sensor]

For example, in a case where only waveform data of a single sensor is used for the anomaly detection service described above, an anomaly point for the monitoring target 2 does not necessarily appear as a statistical singular point even when the waveform data of the sensor is analyzed using various statistical methods. In this case, even when an anomaly occurs in the monitoring target 2, it is not possible to detect the anomaly, whereby a detection omission, which is what is called false-negative, occurs.

Moreover, the singular point analyzed from the waveform data of the sensor using various statistical methods is not necessarily an anomaly point for the monitoring target 2. In this case, an anomaly is detected even though no anomaly has occurred in the monitoring target 2, whereby erroneous detection, which is what is called false-positive, occurs.

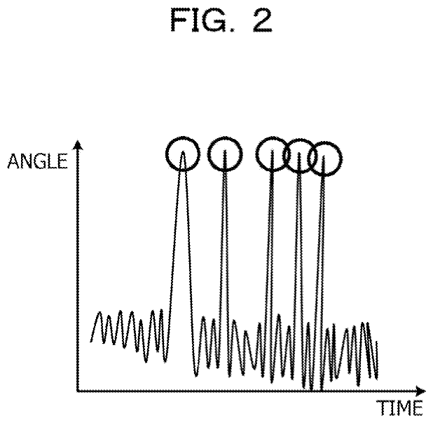

FIG. 2 is a diagram illustrating exemplary waveform data of a sensor. FIG. 2 illustrates time-series data of a wind direction as merely an example of the waveform data of the sensor. The vertical axis of the graph illustrated in FIG. 2 represents an angle of the wind direction, and the horizontal axis represents time. For example, a case where a direction of wind blowing from a traveling direction of a ship is set as 0° and is expressed clockwise from that point is exemplified for the angle of the wind direction.

As indicated by circles in FIG. 2, the waveform data of the sensor includes spike noise. Such spike noise may be detected as singular points by data analysis performed using various statistical methods as merely an example. However, even when the wind direction is fixed, a rudder of the ship may be temporarily shaken due to disturbance, which is, for example, an influence of waves. For example, in a case where the angle of the wind direction fluctuates between 0° and 360° due to a temporary shake of the rudder, a sharp change in the measured value is observed even if the actual wind direction is fixed, whereby it may appear as spike noise in the waveform of the measured value. In this case, the anomaly in the wind direction is detected even though there is no change in the wind direction, whereby erroneous detection occurs.

In order to suppress such erroneous detection, it may need to cooperate with an expert and the like who has specialized knowledge such as characteristics of a true wind direction sensor, which is, for example, a wind direction and wind speed sensor, a disturbance factor peculiar to a ship, which is, for example, an influence of waves on the rudder, and the like. For example, work of requesting analysis from various viewpoints such as sensor characteristics and disturbance factors to an expert and the like, and work in which a developer or the like of the anomaly detection service described above conducts an interview with the expert from the viewpoint of suppressing the false-positive and the false-negative may be needed. For example, in a case of generating a model for performing anomaly detection by machine learning or the like, the developer of the anomaly detection service described above needs to assign a label corresponding to a correct class, such as presence or absence of anomalies, to the waveform data of the sensor to be used as training data. However, without specialized knowledge such as sensor characteristics and disturbance factors, it is difficult to distinguish between a normal point and an anomaly point in the waveform data of the sensor, whereby it is not possible to set an appropriate label to the training data.

Note that, although the true wind direction is exemplified as an exemplary sensor here, the expert in charge differs depending on a type of the sensor. For example, in a case of detecting an anomaly from a sensor of shaft rotation, fuel consumption, or the like around the engine, cooperation of an engine expert is needed. Moreover, while the example in which the monitoring target 2 is a ship has been given, in a case where the monitoring target 2 is an individual other than the ship, which is, for example, a car or a factory, cooperation of an expert is needed for each type of the monitoring target 2 and sensors mounted on the monitoring target 2.

As described above, there is an aspect that the accuracy is limited if the anomaly detection is performed on the monitoring target 2 using the waveform data of a single sensor.

[2.2 Anomaly Detection Using Multiple Sensors]

Having said that, even in a case of using waveform data of multiple sensors for the anomaly detection service described above, the fact that a statistical singular point does not necessarily correspond to an anomaly point for the monitoring target 2 does not change, and thus there is still room for occurrence of erroneous detection. Moreover, it is difficult to extract only the waveform data of the sensor that is of importance to detection of the anomaly point corresponding to the target anomaly. For example, while there are more than 40 types of sensors to be mounted on a ship, it is difficult to pick up only waveform data of sensors of types useful for detecting the anomaly point corresponding to the target anomaly from among them. In view of the above, even in the case of using the waveform data of multiple sensors for the anomaly detection service described above, it is difficult to suppress a decrease in accuracy of the anomaly detection of the monitoring target 2.

[2.3 Invariant Analysis]

Furthermore, there has been proposed a technique called invariant analysis in which a large amount of measurement data is collected from a large number of sensors and a relationship between sensors in a normal period is modeled. Specifically, for example, for each combination of two pieces of measurement data, a transformation function that takes one as an input and outputs the other one and its weight are derived, thereby generating a correlation model. Thereafter, when new measurement data is obtained, a prediction error is calculated from a predicted value of the other one of the measurement data calculated by inputting one of the measurement data to the transformation function having a weight of equal to or greater than a predetermined value among the transformation functions included in the correlation model and an actually measured value of the other one of the measurement data. In a case where the prediction error calculated in this manner is equal to or greater than a certain value, an anomaly is detected.

However, according to the invariant analysis described above, there is an aspect that the accuracy in anomaly detection decreases when the waveform data of the sensor has no periodicity. For example, the invariant analysis described above implements anomaly detection by actual versus forecast comparison. Therefore, the accuracy in anomaly detection depends on the accuracy in calculation of a predicted value, which indicates how close the predicted value of the other one of the measurement data calculated using the transformation function described above may be to the other one of the measurement data in the normal time when there is no anomaly. However, since the transformation function is derived by linear approximation performed between one of the measurement data and the other one of the measurement data, it is difficult to maintain the accuracy in calculation of the predicted value described above if there is no periodicity in each measurement data. As described above, the accuracy in anomaly detection decreases as the accuracy in calculation of the predicted value described above decreases. Moreover, according to the invariant analysis described above, the waveform data of the sensor to which the anomaly detection is applicable is limited to the data with periodicity, and there is an aspect that general versatility is lacking, accordingly.

[2.4 Summary of Each Aspect of Problem]

Therefore, in any of the techniques explained in the sections 2.1 to 2.3 described above, there is an aspect that the accuracy in anomaly detection decreases.

### 3. One Aspect of Problem-Solving Approach

In view of the above, the anomaly detection device 10 according to the present embodiment identifies multiple correlated waveform data among multiple waveform data obtained from each of the multiple sensors arranged on the monitoring target 2. Then, the anomaly detection device 10 according to the present embodiment detects, as an anomaly point, a singular point between the multiple waveform data, which is, a time point at which a correlation breakdown occurs.

[3.1 Correlation Breakdown and Anomaly Point]

The idea of adopting the problem-solving approach described above may be obtained with the technical knowledge that the correlation breakdown between the multiple waveform data correlated with each other is highly likely to correspond to the anomaly point for the monitoring target 2.

Among the sensors mounted on the monitoring target 2 represented by a mobile object such as a ship or a car, there may be objects having a correlation in terms of time change. For example, in an exemplary case of a ship, an engine output, screw rotation speed, and engine temperature are highly likely to correlate with each other.

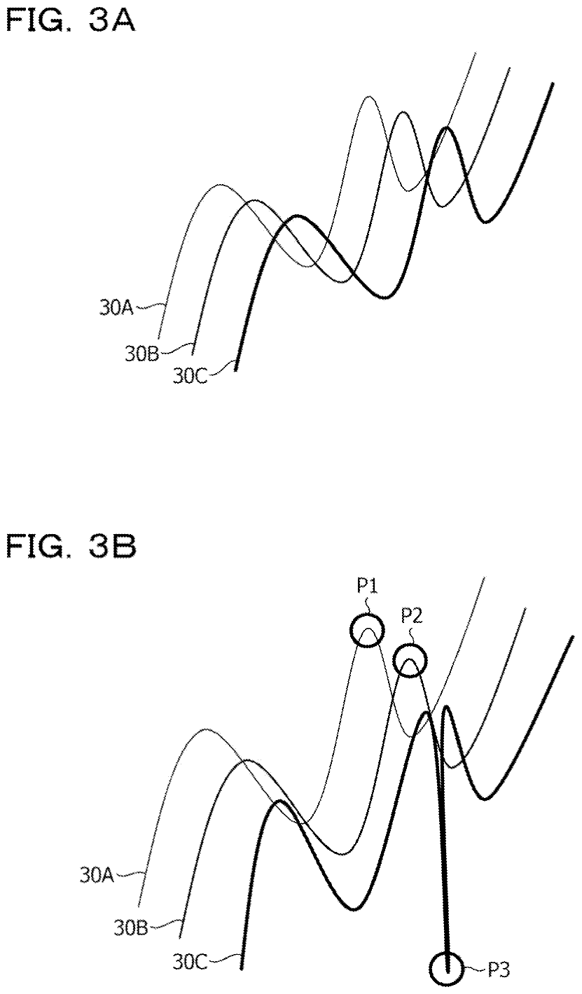

FIGS. 3A and 3B are diagrams illustrating exemplary waveform data of the sensors. FIGS. 3A and 3B illustrate waveforms 30A to 30C corresponding to the time-series data of the measured values of the sensors 3A to 3C correlated with each other among the N sensors 3A to 3N arranged on the monitoring target 2.

As illustrated in FIG. 3A, since the waveforms 30A to 30C are correlated with each other, transitions of changes such as increase and decrease tend to be similar. In such a situation where a correlative relationship is established between the waveforms 30A to 30C, a singular point between the waveforms 30A to 30C, which is a correlation breakdown, is highly likely to be an anomaly point of the monitoring target 2.

FIG. 3B exemplifies a singular point P3 between the waveforms 30A to 30C correlated with each other. As illustrated in FIG. 3B, while a peak P1 and a peak P2 are observed at the same or similar time in the waveforms 30A and 30B, a dip P3 is observed at time same as or similar to the time at which the peak P1 and the peak P2 are observed in the waveform 30C. Here, it may be said that the dip P3 observed in the waveform 30C is a singular point at which the measured value is extremely different from the peak P1 observed in the waveform 30A and the peak P2 observed in the waveform 30B, which is, a correlation breakdown.

Such a correlation breakdown is highly likely to correspond to an anomaly point for the monitoring target 2. This is because the technical knowledge described above is supported by an empirical rule that the number of occurrences of an anomalous value is extremely smaller than a normal value in the monitoring target 2 in operation or in action.

[3.2 Identification of Waveform with Correlative Relationship]

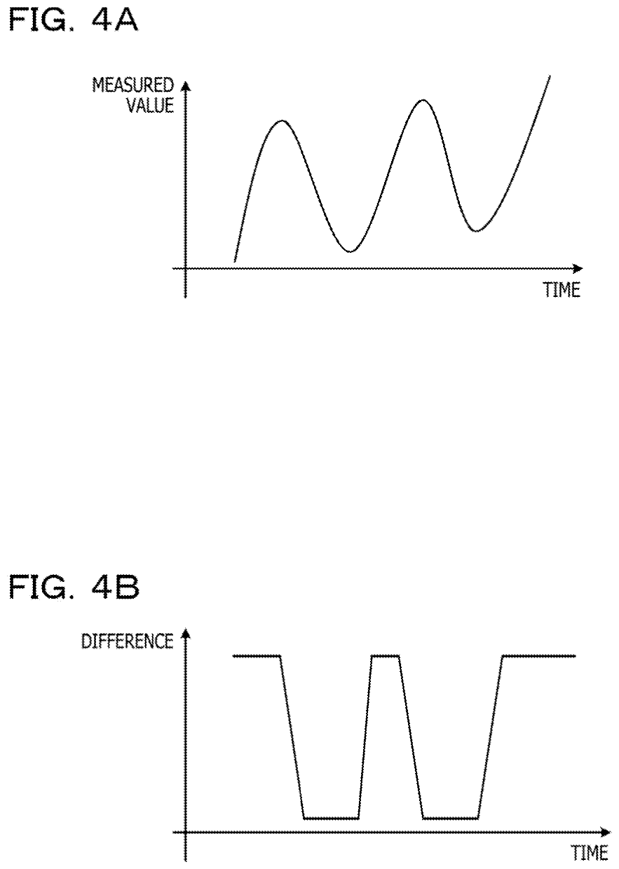

As merely an example, the anomaly detection device 10 according to the present embodiment performs the following processing for each waveform data of the N sensors 3A to 3N arranged on the monitoring target 2. FIG. 4A is a schematic diagram illustrating exemplary waveform data after regularization, and FIG. 4B is a schematic diagram illustrating exemplary waveform data of a difference. For example, with the measured value included in the waveform data of a certain sensor 3 regularized in the range of −1 to 1, the waveform data after the regularization is obtained as illustrated in FIG. 4A. Hereinafter, a value obtained by regularizing a measured value may be referred to as a “regular value”. Thereafter, as illustrated in FIG. 4B, the waveform data of the difference is obtained by performing a calculation in which, for each time t when sampling is performed by the sensor 3, a regular value at the corresponding time t is subtracted from a regular value at the next time t+1.

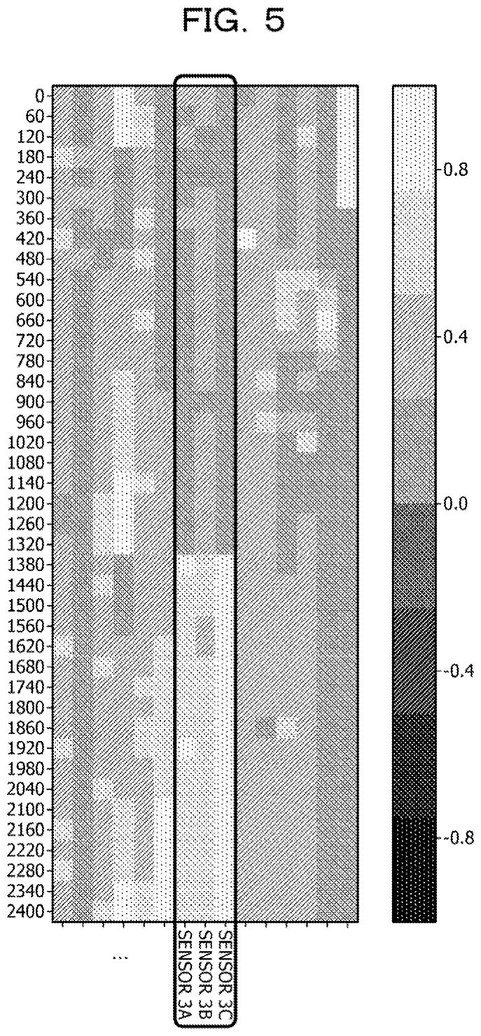

On the basis of the correlation of the N regularized waveform data or difference waveform data obtained in this manner, multiple correlated waveform data are specified as the target waveform data from the N waveform data. As merely an example, it is possible to extract the sensors 3 having similar color changes from a heat map of regular values. FIG. 5 is a diagram illustrating an exemplary heat map of regular values. In FIG. 5, regular values from time “0” to time “2,400” are illustrated in a time series manner for each of the N sensors 3A to 3N. For example, with the heat map of the regular values illustrated in FIG. 5 caused to be displayed on the client terminal 50 or the like, it becomes possible to accept selection of multiple correlated waveform data. In the example illustrated in FIG. 5, it is visually clear that, among the sensor 3A, sensor 3B, and sensor 3C, the change of the regular values from the time “0” to time “1,320” is close to the change of the regular values from the time “1,320” to time “2,400”. Accordingly, with the selection of the sensor 3A, sensor 3B, and sensor 3C accepted, it becomes possible to specify the waveform data of the sensor 3A, sensor 3B, and sensor 3C as the target waveform data.

[3.3 Clustering]

Here, the correlation breakdown between the target waveform data may be identified by performing clustering as an example. At a time of performing the clustering in this manner, with the difference of the same time between the target waveform data combined into one, the difference of the same time is vectorized. For example, when a difference of the sensor 3A at time tᵢ is “d_{A}”, a difference of the sensor 3B is “d_{B}”, and a difference of the sensor 3C is “d_{C}”, d_{A}, d_{B}, and d_{C} are vectorized into tᵢ(d_{A}, d_{B}, d_{C}). Such vectorization is performed from the front time tₛₜₐᵣₜ to the backend time t_{end}.

Then, sets of elements tₛₜₐᵣₜ (d_{A}, d_{B}, d_{C}) to t_{end} (d_{A}, d_{B}, d_{C}) vectorized for each time tᵢ are clustered. According to such clustering, elements close to each other are classified into the same cluster. Moreover, as described above, there is an empirical rule that the number of normal points is greater than that of anomaly points. From those factors, the number of elements belonging to the cluster corresponding to the normal point increases, and the number of elements belonging to the cluster corresponding to the anomaly point decreases. Therefore, the elements included in a small-sized cluster may be detected as anomaly points.

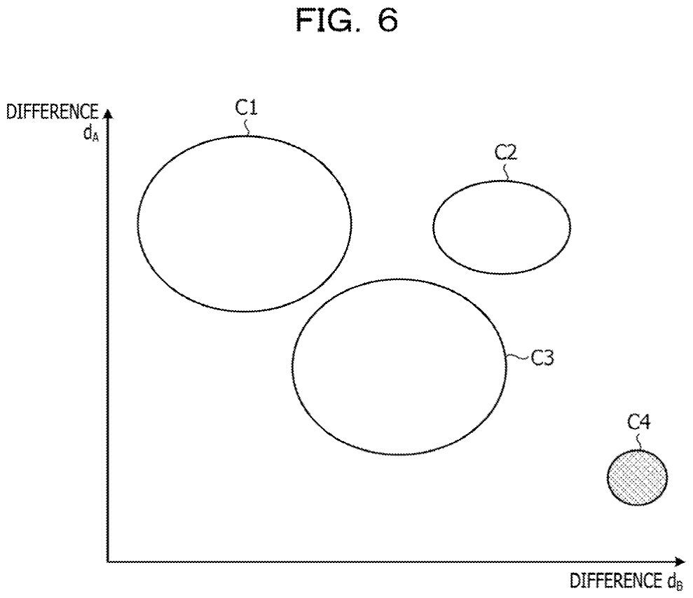

FIG. 6 is a diagram illustrating an exemplary clustering result. While only two axes of the difference d_{A} and the difference d_{B} are excerpted for convenience of explanation in FIG. 6, it is noted that the number of differences contained in one element may be two or more. While an exemplary case where four clusters C1 to C4 are obtained is exemplified in the example illustrated in FIG. 6, an element contained in the cluster C4, which is the smallest in size among those clusters C1 to C4, may be detected as an anomaly point. Note that, while the example of detecting the element contained in the cluster of the smallest size as an anomaly point has been exemplified here as merely an example, it is also possible to detect, as an anomaly point, an element contained in the cluster in which the number of elements is equal to or less than a predetermined threshold value.

[3.4 Summary]

As described above, the anomaly detection device 10 according to the present embodiment clusters a set of elements in which the measured values of the same time are collected into one among the correlated waveform data of the waveform data of the N sensors 3A to 3N, and detects an anomaly on the basis of the size of the cluster. In this manner, multiple correlated waveform data are used for anomaly detection, whereby it becomes possible to increase the possibility that an anomaly point for the monitoring target 2 appears as a singular point. Moreover, a singular point between multiple waveform data, which is a small-sized cluster corresponding to a correlation breakdown, is detected as an anomaly point, whereby it becomes possible to implement anomaly detection without performing, as in the invariant analysis described above, prediction processing for calculating the other one of the measurement data using one of the measurement data. Accordingly, it becomes possible to reduce the influence of the presence or absence of periodicity of the waveform data of the sensor 3 on the accuracy in anomaly detection as compared with the invariant analysis described above. Therefore, according to the anomaly detection device 10 according to the present embodiment, it becomes possible to suppress a decrease in anomaly detection accuracy.

### 4. Configuration of Anomaly Detection Device 10

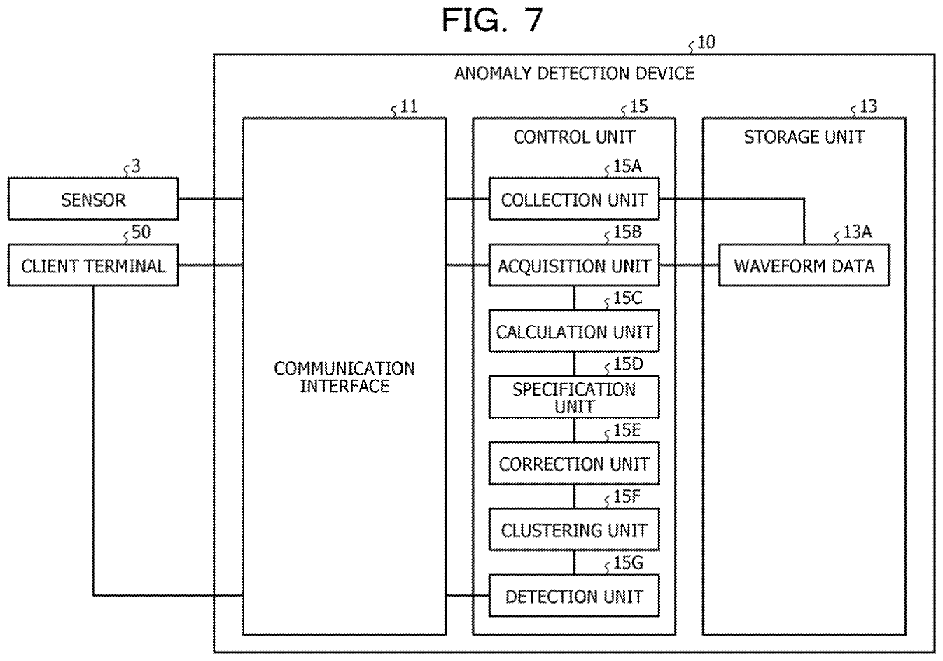

FIG. 7 is a block diagram illustrating a functional configuration of the anomaly detection device 10 according to the first embodiment. As illustrated in FIG. 7, the anomaly detection device 10 includes a communication interface 11, a storage unit 13, and a control unit 15. Note that, while a solid line indicating a relationship of data exchange is illustrated in FIG. 7, only a minimum part is illustrated for convenience of explanation. For example, input and output of data regarding each processing unit are not limited to the illustrated example, and input and output of data other than those illustrated, for example, input and output of data between a processing unit and another processing unit, between a processing unit and data, and between a processing unit and an external device may be performed.

The communication interface 11 is an interface that performs control of communication with another device, which is, for example, the sensor 3 or the client terminal 50.

As merely an example, the communication interface 11 may adopt a network interface card such as a local area network (LAN) card. For example, the communication interface 11 notifies the sensor 3 of a sampling frequency of the sensor 3, uploading timing of a measured value, and the like, and also receives the measured value or time-series data of the measured value from the sensor 3. Furthermore, the communication interface 11 accepts setting of the sensor 3 to be subject to anomaly detection from the client terminal 50, and also notifies the client terminal 50 of the anomaly point of the sensor 3 to be subject to the anomaly detection, which is, for example, the measured value of the element included in the small-sized cluster.

The storage unit 13 is a functional unit that stores data to be used in various programs, such as the anomaly detection program described above, including an operating system (OS) executed by the control unit 15. As merely an example, the storage unit 13 may correspond to an auxiliary storage device in the anomaly detection device 10. For example, a hard disk drive (HDD), an optical disk, a solid state drive (SSD), or the like may correspond to the auxiliary storage device. In addition, a flash memory such as an erasable programmable read only memory (EPROM) may also correspond to the auxiliary storage device.

The storage unit 13 stores waveform data 13A as merely an example of data to be used in the program to be executed in the control unit 15. In addition to the waveform data 13A, account information of a service subscriber of the anomaly detection service described above and the like may be stored in the storage unit 13. Note that descriptions about the waveform data 13A will be given together with descriptions about the control unit 15 in which collection and registration of the waveform data 13A is performed.

The control unit 15 is a functional unit that performs overall control of the anomaly detection device 10.

As one embodiment, the control unit 15 may be implemented by a hardware processor such as a central processing unit (CPU) or a micro-processing unit (MPU). While a CPU and an MPU are exemplified as an example of the processor here, it may be implemented by any processor regardless of whether it is general-purpose type or a specialized type. In addition, the control unit 15 may also be implemented by a hard wired logic such as an application specific integrated circuit (ASIC) or a field programmable gate array (FPGA).

By executing the anomaly detection program described above, the control unit 15 virtually implements the processing units illustrated in FIG. 7 on a work area of a random access memory (RAM) such as a dynamic random access memory (DRAM) mounted as a main storage device (not illustrated).

For example, as illustrated in FIG. 7, the control unit 15 includes a collection unit 15A, an acquisition unit 15B, a calculation unit 15C, a specification unit 15D, a correction unit 15E, a clustering unit 15F, and a detection unit 15G.

The collection unit 15A is a processing unit that collects waveform data of the sensor 3.

As merely an example, the collection unit 15A is capable of collecting measured values in real time from the N sensors 3A to 3N arranged on the monitoring target 2. As another example, the collection unit 15A is also capable of collecting time-series data of measured values from the sensors 3A to 3N over a predetermined period of time, which is, for example, 1 minute, 1 hour, 12 hours, 1 day, 1 week, 1 month, or the like. The waveform data collected from the sensors 3A to 3N in this manner is stored in the storage unit 13 as the waveform data 13A.

The acquisition unit 15B is a processing unit that obtains the waveform data of the sensor 3 accumulated in the storage unit 13. While an exemplary case where the anomaly detection program for implementing the anomaly detection service described above obtains the waveform data of the sensor 3 from the storage unit 13 is described as an example here, the waveform data of the sensor 3 may be obtained via a removable medium or a network.

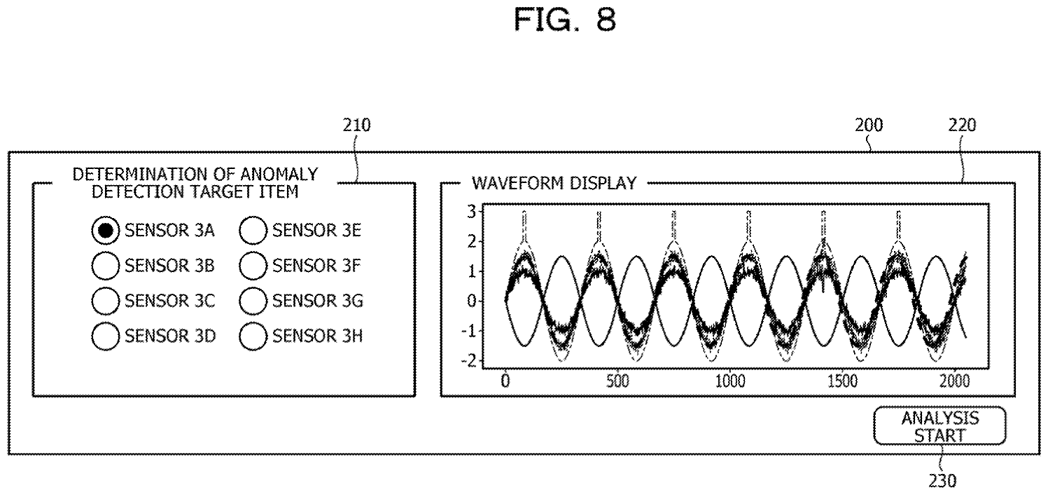

As one embodiment, the acquisition unit 15B receives a request for analyzing the sensor 3 to be subject to the anomaly detection. FIG. 8 is a diagram illustrating an exemplary analysis request screen. While a case of including eight sensors 3 of sensors 3A to 3H is exemplified as merely an example in FIG. 8, the number of the sensors 3 may be any number N. An analysis request screen 200 illustrated in FIG. 8 may be displayed on the client terminal 50 as merely an example. The analysis request screen 200 includes an area 210 for selecting an anomaly detection target and an area 220 for displaying the waveform data of each of the sensors 3. Of them, the area 210 includes radio buttons corresponding to the sensors 3A to 3H. Furthermore, the waveform data of the sensors 3A to 3H are displayed in the area 220. In a case where an operation on an analysis start button 230 is received while any one of those radio buttons corresponding to the sensors 3A to 3H is selected, an analysis request in which the sensor 3 corresponding to the selected button is subject to the anomaly detection is accepted. When the analysis request is accepted in this manner, the acquisition unit 15B reads the waveform data 13A stored in the storage unit 13, thereby obtaining the waveform data of the N sensors 3A to 3N. For example, the acquisition unit 15B obtains waveform data for a predetermined period of time, which is, for example, 1 hour, 12 hours, or 1 day, for each of the sensors 3. Note that, while a case of obtaining the waveform data of each of the sensors 3 from the storage unit 13 is exemplified here, the waveform data may be obtained from the sensor 3.

The calculation unit 15C is a processing unit that calculates a correlation coefficient.

As one embodiment, the calculation unit 15C carries out the process described with reference to FIGS. 4A and 4B for each of the waveform data of the sensors 3A to 3N obtained by the acquisition unit 15B. For example, the calculation unit 15C regularizes the measured value included in the waveform data of the sensor 3 in the range of −1 to 1. As a result, the waveform data after the regularization is obtained as illustrated in FIG. 4A. Thereafter, the calculation unit 15C performs a calculation in which, for each time t when sampling is performed by the sensor 3, the regular value at the corresponding time t is subtracted from the regular value at the next time t+1. As a result, the waveform data of the difference is obtained as illustrated in FIG. 4B. As a result of performing the process such as the regularization and the calculation of the difference for each of the sensors 3, the waveform data of the difference is obtained for each of the sensors 3. Then, the calculation unit 15C calculates a correlation coefficient between the paired two pieces of waveform data of the differences for each pair of the sensors 3.

The specification unit 15D is a processing unit that measures target waveform data among multiple waveform data on the basis of a correlation between shapes of the multiple waveform data.

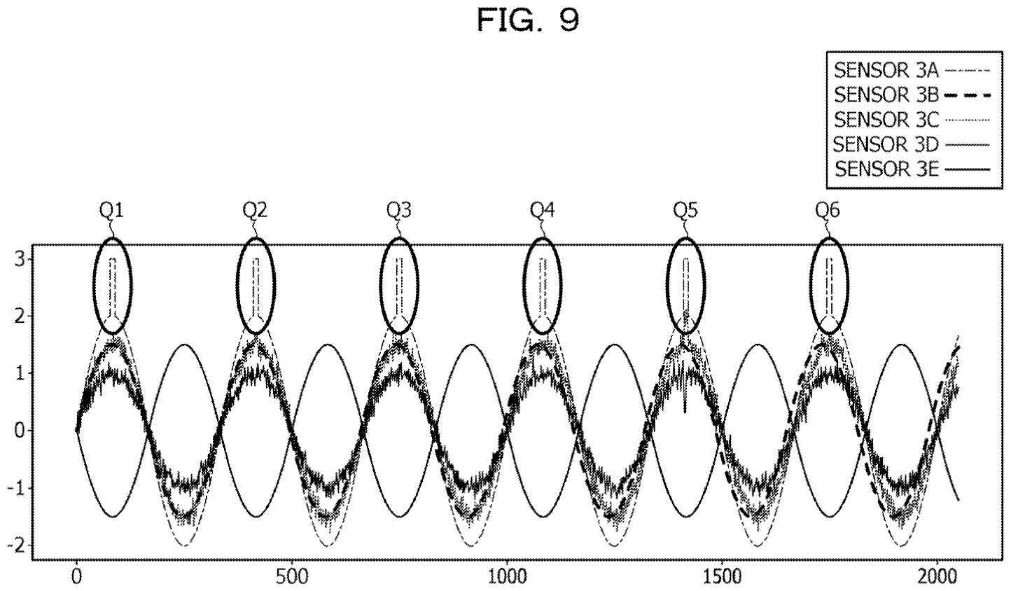

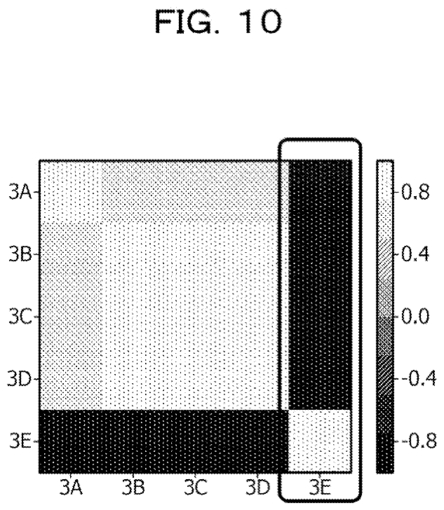

FIG. 9 is a diagram illustrating exemplary waveform data of the sensor 3. In FIG. 9, waveform data of measured values of the sensors 3A to 3E are illustrated as merely an example. Moreover, as illustrated in the key of FIG. 9, the measured value of the sensor 3A is indicated by a dash-dot line (thin), the measured value of the sensor 3B is indicated by a broken line (thick), the measured value of the sensor 3C is indicated by a dotted line (thin), the measured value of the sensor 3D is indicated by a solid line (thin), and the measured value of the sensor 3E is indicated by a solid line (middle). With the process described above performed for each of the waveform data of the sensors 3A to 3E, the waveform data of the difference is obtained for each of the sensors 3A to 3E. Then, the correlation coefficient of the waveform data of the difference is calculated for each pair of the sensors 3A to 3E. As a result, a map of correlation coefficients illustrated in FIG. 10 is obtained.

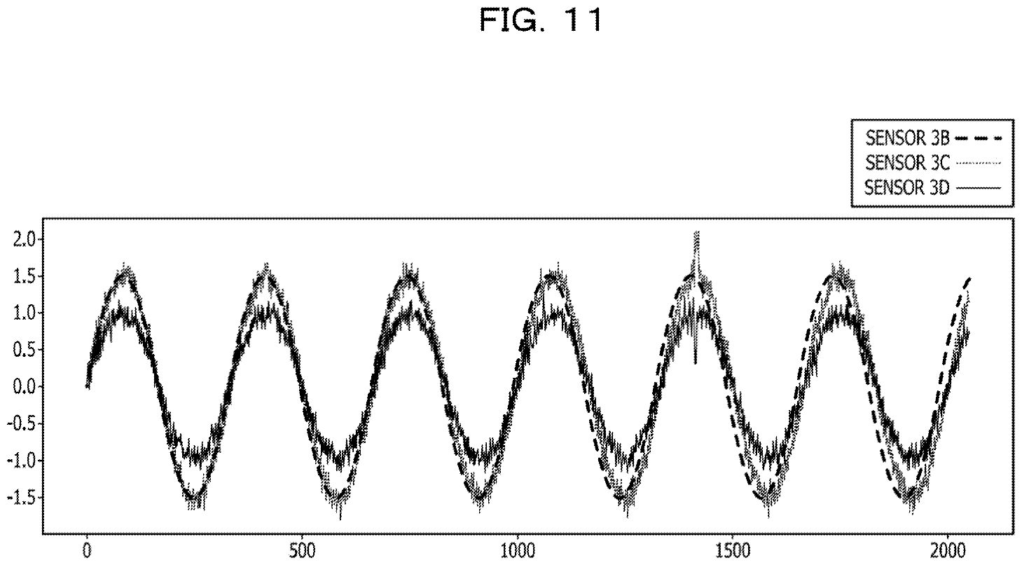

FIG. 10 is a diagram illustrating an exemplary map of correlation coefficients. Here, assuming that the sensor 3A is set as an anomaly detection target, the correlation coefficient between the waveform data of the difference of the sensor 3A set as the anomaly detection target and the waveform data of the differences of the other sensors 3B to 3E is referred to in the map of the correlation coefficients illustrated in FIG. 10. As merely an example, when a threshold value to be compared with the correlation coefficient is set to “0.6”, the correlation coefficient between the waveform data of the difference of the sensor 3A and the waveform data of the differences of the sensors 3B to 3D is equal to or greater than the threshold value “0.6”. Meanwhile, the correlation coefficient between the waveform data of the difference of the sensor 3A and the waveform data of the difference of the sensor 3E is less than the threshold value “0.6”. Accordingly, it is possible to specify that the waveform data of the sensors 3B to 3D among the waveform data of the sensors 3B to 3E are highly likely to have a positive correlation with the waveform data of the sensor 3A to be subject to the anomaly detection. Meanwhile, it is possible to specify that the waveform data of the sensor 3E is highly likely to have no positive correlation with the waveform data of the sensor 3A to be subject to the anomaly detection. In this case, the waveform data to be analyzed is specified as illustrated in FIG. 11.

FIG. 11 is a diagram illustrating exemplary waveform data to be analyzed. As illustrated in FIG. 11, while the waveform data of the sensors 3B to 3E are specified as the analysis target, the waveform data of the sensor 3E is excluded from the analysis target.

Note that, while a case where the sensor 3 to be analyzed is specified using the correlation coefficient as an example of a degree of similarity is exemplified here, the sensor 3 to be analyzed may be specified using another degree of similarity for evaluating a shape of a waveform. Furthermore, while a case of automatically specifying the sensor 3 to be analyzed is exemplified here, it is not limited thereto, and the sensor 3 to be analyzed may also be manually specified. For example, as described with reference to FIG. 5, it is also permissible if selection of the sensor 3 to be used as the analysis target of the sensor 3A to be subject to the anomaly detection is accepted while a heat map of regular values is displayed on the client terminal 50.

The correction unit 15E is a processing unit that corrects the waveform data of the difference of the sensor 3 to be analyzed.

As merely an example, a situation where the sensor 3A is set as the anomaly detection target and the sensors 3B to 3D are specified as the analysis target according to the examples of FIGS. 9 to 11 is exemplified. In this case, the correction unit 15E performs regression analysis for calculating a weight of a linear regression model in which the waveform data of the difference of the sensor 3A set as the anomaly detection target is used as an objective variable and the waveform data of the difference of the sensors 3B to 3D specified as the analysis target by the specification unit 15D is used as an explanatory variable. As merely an example, Lasso regression may be used for such regression analysis. For example, the following equation (1) may be used as an example of the linear regression model. In the equation (1) set out below, “d_{A}” represents the difference of the sensor 3A, “d_{B}” represents the difference of the sensor 3B, “d_{C}” represents the difference of the sensor 3C, and “d_{D}” represents the difference of the sensor 3D. Furthermore, “α₁” to “α₃” in the equation (1) represent weights given to the sensors 3B to 3D. Note that “ε” represents an error.

d_{A}=α₁*d_{B}+α₂*d_{C}+α₃*d_{D}+£ (1)

The correction unit 15E corrects the waveform data of the differences of the sensors 3B to 3D specified as the analysis target using the weights “α₁” to “α₃” obtained as a result of the regression analysis described above. For example, correction of multiplying the weight α₁ is made on the difference d_{B} of the sensor 3B. Furthermore, correction of multiplying the weight α₂ is made on the difference d_{C} of the sensor 3C. Moreover, correction of multiplying the weight α₃ is made on the difference d_{D} of the sensor 3D. Hereinafter, the difference after the correction of multiplying the weight may be referred to as a “weighted difference”.

Here, the correction described above is made because not only the sensors highly correlated with the sensor 3A set as the anomaly detection target are specified as the analysis target. For example, in a case where a sensor having a not very high correlation with the sensor 3A set as the anomaly detection target is specified as the analysis target, the correction described above is made from the aspect of suppressing the waveform data of the difference of the sensor having a not very high correlation becoming noise at the time of clustering. For example, even when the sensor having a not very high correlation with the sensor 3A set as the anomaly detection target is specified as the analysis target, the difference of the regular value of the sensor is multiplied by a small weight, whereby it becomes possible to suppress the noise at the time of clustering.

The clustering unit 15F is a processing unit that clusters a set of elements in which weighted differences of the same time are combined into one among the waveform data of the sensor 3 specified as the analysis target.

As one embodiment, the clustering unit 15F combines, into one, the weighted differences of the same time among the waveform data of the weighted differences of the sensors to be analyzed corrected by the correction unit 15E, thereby vectorizing the weighted differences of the same time. For example, when the sensors 3B to 3D are specified as the analysis target, the weighted difference “α₁*d_{B}” of the sensor 3B, the weighted difference “α₂*d_{C}” of the sensor 3C, and the weighted difference “α₃*d_{D}” of the sensor 3D are vectorized into tᵢ(α₁*d_{B}, α₂*d_{C}, α₃*d_{D}). Such vectorization is performed from the front time tₛₜₐᵣₜ to the backend time t_{end}. Besides, the clustering unit 15F clusters the sets of elements tₛₜₐᵣₜ(α₁*d_{B}, α₂*d_{C}, α₃*d_{C}) to t_{end}(α₁*d_{B}, α₂*d_{C}, α₃*d_{D}) vectorized for each time tᵢ.

The detection unit 15G is a processing unit that detects an anomaly of the monitoring target 2 on the basis of the size of the cluster.

As one aspect, the detection unit 15G is also capable of detecting, as an abnormal cluster, a cluster in which the number of elements is less than a predetermined threshold value among the clusters obtained as a result of the clustering performed by the clustering unit 15F.

As another aspect, the detection unit 15G is capable of detecting, as an abnormal cluster, a predetermined number of clusters in ascending order of the number of elements included in the respective clusters among the clusters obtained as a result of the clustering performed by the clustering unit 15F.

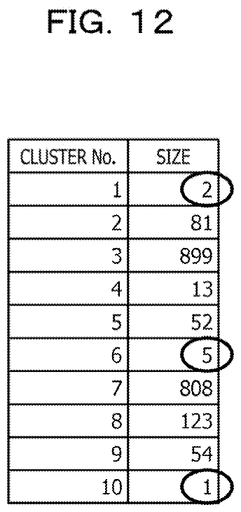

FIG. 12 is a diagram illustrating an exemplary clustering result. FIG. 12 illustrates a result obtained by clustering the sets of elements tₛₜₐᵣₜ(α₁*d_{B}, α₂*d_{C}, α₃*d_{C}) to t_{end}(α₁*d_{B}, α₂*d_{C}, α₃*d_{C}) in which the weighted differences of the same time are vectorized for each time t among the waveform data of the weighted differences of the sensors 3B to 3D to be analyzed. In the example illustrated in FIG. 12, the sets of elements tₛₜₐᵣₜ(α₁*d_{B}, α₂*d_{C}, α₃*d_{D}) to t_{end}(α₁*d_{B}, α₂*d_{C}, α₃*d_{D}) are classified into ten clusters of clusters No. 1 to No. 10. Here, when the threshold value to be compared with the number of elements is set to “10”, three clusters of the cluster No. 1, the cluster No. 6, and the cluster No. 10, which are less than the threshold value “10”, are detected as abnormal clusters.

Here, in a case where the abnormal cluster is detected, the detection unit 15G may output various alerts. For example, the detection unit 15G is capable of causing the element in which the abnormal cluster is detected in the waveform data to be analyzed, which is the time and the measured value of the anomaly point corresponding to the correlation breakdown, to be displayed in an emphasized manner. Furthermore, the detection unit 15G is capable of causing the element in which the abnormal cluster is detected in the waveform data to be subject to the anomaly detection, which is the time and the measured value of the anomaly point corresponding to the correlation breakdown, to be displayed in an emphasized manner. Note that the detection unit 15G may cause not only drawing of the anomaly point based on a figure but also a numerical value related to the time and the measured value of the anomaly point to be displayed.

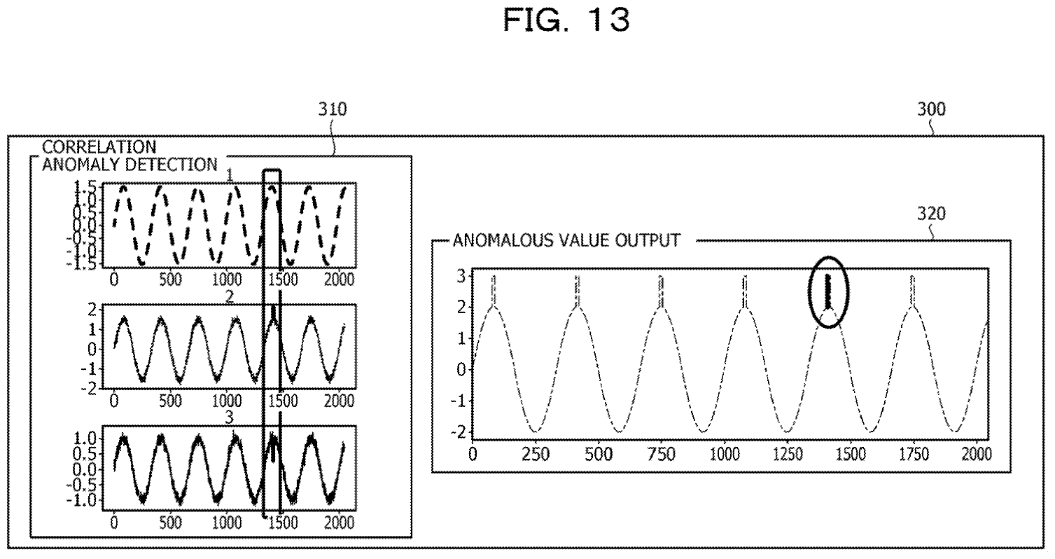

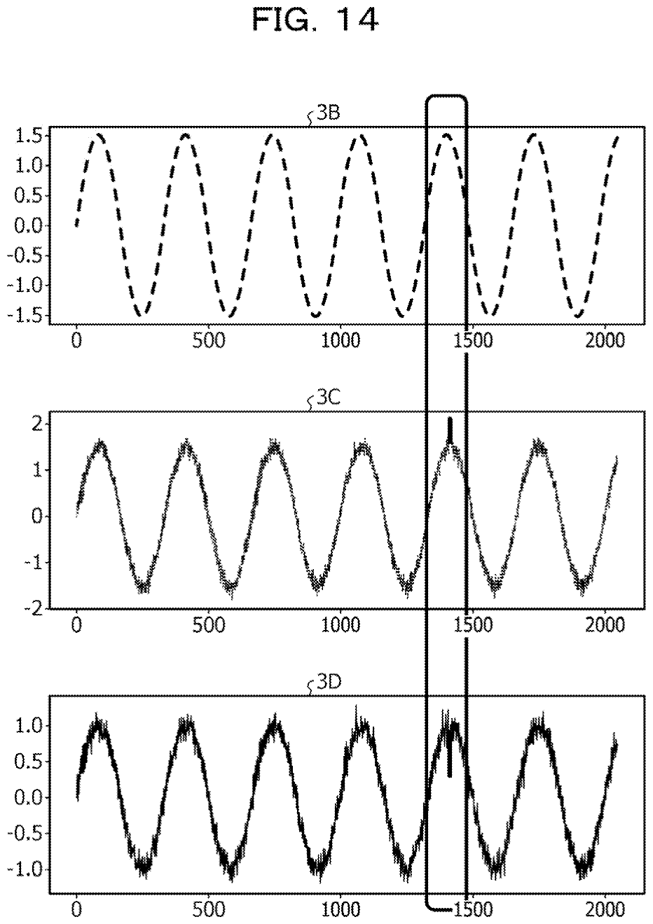

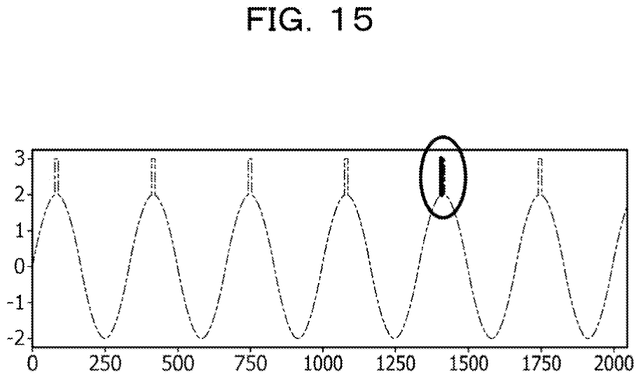

FIG. 13 is a diagram illustrating an exemplary alert screen. As illustrated in FIG. 13, an alert screen 300 may include a display area 310 in which the waveform data to be analyzed is displayed and a display area 320 in which the waveform data to be subject to the anomaly detection is displayed. Of them, an enlarged view of the display area 310 is illustrated in FIG. 14, and an enlarged view of the display area 320 is illustrated in FIG. 15.

FIG. 14 is an enlarged view of the display area 310. FIG. 14 illustrates the waveform data of the sensor 3B, the waveform data of the sensor 3C, and the waveform data of the sensor 3D specified as the analysis target. Moreover, in FIG. 14, a section corresponding to the element in which the abnormal cluster is detected among the waveform data of the sensor 3B, the waveform data of the sensor 3C, and the waveform data of the sensor 3D is indicated by being surrounded by a frame. Moreover, in FIG. 14, the element in which the abnormal cluster is detected in the waveform data of the sensor 3C, which is a portion of the measured value corresponding to the correlation breakdown (upward fluctuated portion of the peak), is indicated by being emphasized with a thick line, and the element in which the abnormal cluster is detected in the waveform data of the sensor 3D, which is a portion of the measured value corresponding to the correlation breakdown (downward fluctuated portion of the peak), is indicated by being emphasized with a thick line. With those displays, it becomes possible to clearly indicate the points corresponding to the correlation breakdown.

FIG. 15 is an enlarged view of the display area 320. FIG. 15 illustrates the waveform data of the sensor 3A set as the anomaly detection target. Moreover, in FIG. 15, the element in which the abnormal cluster is detected in the waveform data of the sensor 3A, which is a portion of the measured value corresponding to the anomaly point, is indicated by being emphasized with a thick line and surrounded by an elliptical thick line. With such display, it becomes possible to clearly indicate the anomaly point of the monitoring target 2. For example, while the waveform data of the sensor 3A includes spikes Q1 to Q6 that seem to be noise at a glance as indicated by elliptical frames in FIG. 9, it becomes possible to grasp that an anomaly has occurred only in the spike Q5 by referring to the display of the anomaly point illustrated in FIG. 15.

### 5. Process Flow

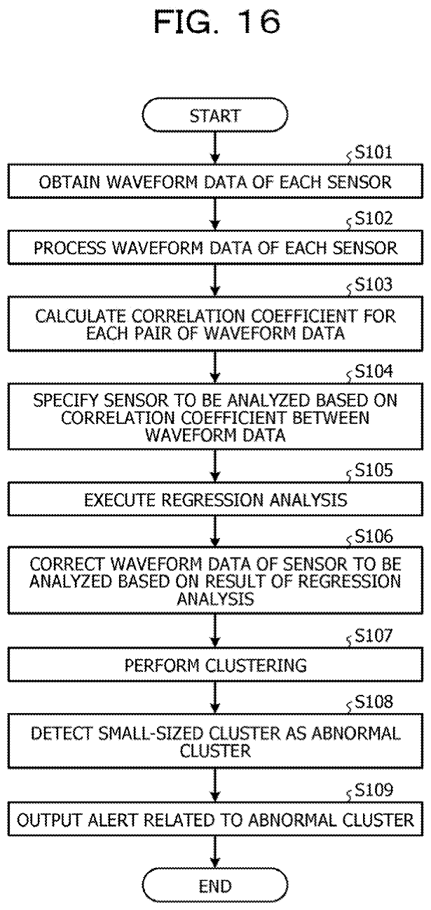

FIG. 16 is a flowchart illustrating a procedure of the anomaly detection process according to the first embodiment. This process is executed when a request for analyzing the sensor 3 to be subject to the anomaly detection is received as merely an example.

As illustrated in FIG. 16, the acquisition unit 15B reads the waveform data 13A stored in the storage unit 13, thereby obtaining the waveform data of each of the sensors 3 (step S101). Subsequently, the calculation unit 15C performs a process of regularizing the measured value, calculating the difference, and the like for each of the waveform data of the sensors 3A to 3N obtained in step S101 (step S102). As a result, the waveform data of the difference is obtained for each of the sensors 3A to 3N.

Then, the calculation unit 15C calculates a correlation coefficient between the paired two pieces of waveform data of the differences for each pair of the sensors 3A to 3N (step S103). Next, the specification unit 15D specifies, among the sensors 3B to 3N other than the sensor 3A set as the anomaly detection target, the sensors 3B to 3D in which the correlation coefficient between the waveform data of the difference of the sensor 3A set as the anomaly detection target and the waveform data of the differences of the other sensors 3B to 3N is equal to or higher than a predetermined threshold value as an analysis target (step S104).

Then, the correction unit 15E performs regression analysis for calculating a weight of the linear regression model in which the waveform data of the difference of the sensor 3A set as the anomaly detection target is used as an objective variable and the waveform data of the difference of the sensors 3B to 3D specified as the analysis target in step S104 is used as an explanatory variable (step S105).

Thereafter, the correction unit 15E makes a correction of multiplying the differences d_{B}, d_{C}, and d_{D} of the sensors 3B to 3D specified as the analysis target by the weights α₁, α₂, α₃ of the linear regression model obtained as a result of the regression analysis in step S105 (step S106).

Then, the clustering unit 15F combines, into one, the weighted differences of the same time among the waveform data of the weighted differences of the sensors to be analyzed corrected in step S106, thereby vectorizing the weighted differences of the same time. Besides, the clustering unit 15F clusters the sets of elements tₛₜₐᵣₜ(α₁*d_{B}, α₂*d_{C}, α₃*d_{D}) to t_{end}(α₁*d_{B}, α₂*d_{C}, α₃*d_{D}) vectorized for each time tᵢ (step S107).

Thereafter, the detection unit 15G detects, as an abnormal cluster, a cluster in which the number of elements is less than a predetermined threshold value among the clusters obtained as a result of the clustering performed by the clustering unit 15F (step S108). Finally, the detection unit 15G outputs various alerts related to the abnormal cluster, which is, for example, the alert screen 300 illustrated in FIG. 13, to the client terminal 50 (step S109), and the process is terminated.

### 6. One Aspect of Effects of Embodiments

As described above, the anomaly detection device 10 according to the present embodiment clusters a set of elements in which the measured values of the same time are collected into one among the correlated waveform data of the waveform data of the multiple sensors, and detects an anomaly on the basis of the size of the cluster. Therefore, according to the anomaly detection device 10 according to the present embodiment, it is possible to suppress a decrease in anomaly detection accuracy.

### Second Embodiment

While the embodiment related to the disclosed device has been described above, the disclosed technology may be carried out in a variety of different modes in addition to the embodiment described above. Thus, hereinafter, another embodiment included in the disclosed technology will be described.

### 7. Distribution and Integration

Furthermore, each of the illustrated components in each of the devices is not necessarily physically configured as illustrated in the drawings. For example, specific aspects of distribution and integration of the respective devices are not limited to those illustrated, and all or some of the devices may be functionally or physically distributed and integrated in an optional unit depending on various loads, use situations, and the like. For example, the collection unit 15A, the acquisition unit 15B, the calculation unit 15C, the specification unit 15D, the correction unit 15E, the clustering unit 15F, or the detection unit 15G may also be connected via a network as an external device of the anomaly detection device 10. Furthermore, each of different devices may include the collection unit 15A, the acquisition unit 15B, the calculation unit 15C, the specification unit 15D, the correction unit 15E, the clustering unit 15F, or the detection unit 15G to cooperate with each other while being connected via a network, whereby the functions of the anomaly detection device 10 described above may also be implemented.

### 8. Anomaly Detection Program

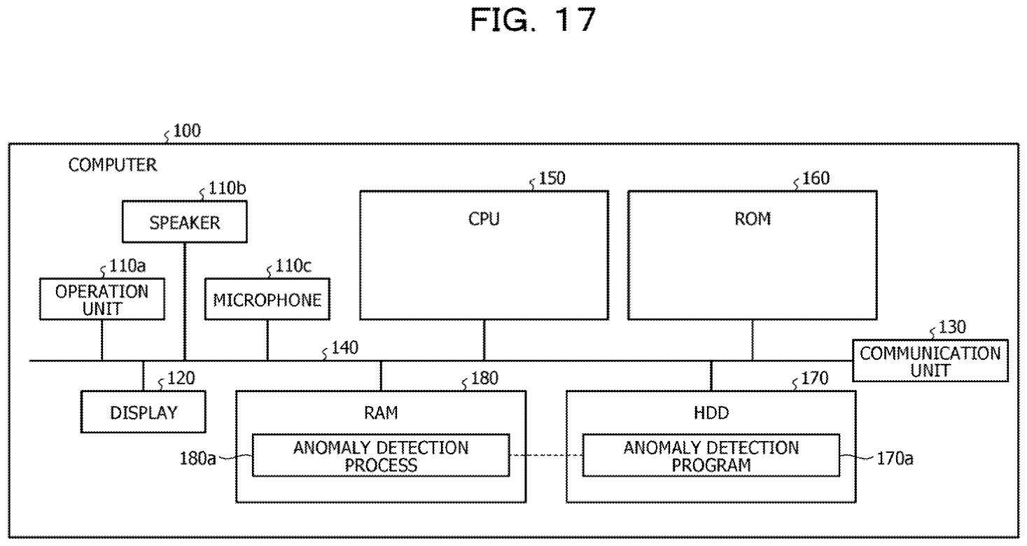

Furthermore, various types of processing described in the embodiments above may be implemented by a computer such as a personal computer or a workstation executing a program prepared in advance. In view of the above, hereinafter, an exemplary computer that executes an anomaly detection program having functions similar to those in the embodiments described above will be described with reference to FIG. 17.

FIG. 17 is a diagram illustrating an exemplary hardware configuration of a computer. As illustrated in FIG. 17, a computer 100 includes an operation unit 110a, a speaker 110b, a camera 110c, a display 120, and a communication unit 130. Moreover, the computer 100 includes a central processing unit (CPU) 150, a read-only memory (ROM) 160, a hard disk drive (HDD) 170, and a random-access memory (RAM) 180. Those components 110 to 180 are each connected via a bus 140.

As illustrated in FIG. 17, the HDD 170 stores an anomaly detection program 170a that implements functions similar to those of the collection unit 15A, the acquisition unit 15B, the calculation unit 15C, the specification unit 15D, the correction unit 15E, the clustering unit 15F, and the detection unit 15G mentioned in the first embodiment described above. The anomaly detection program 170a may be integrated or separated in a similar manner to the respective components of the collection unit 15A, the acquisition unit 15B, the calculation unit 15C, the specification unit 15D, the correction unit 15E, the clustering unit 15F, and the detection unit 15G illustrated in FIG. 7. For example, all the data indicated in the first embodiment described above are not necessarily stored in the HDD 170, and it is sufficient if only data for use in processing is stored in the HDD 170.

Under such an environment, the CPU 150 reads out the anomaly detection program 170a from the HDD 170, and loads it in the RAM 180. As a result, the anomaly detection program 170a functions as an anomaly detection process 180a as illustrated in FIG. 17. The anomaly detection process 180a loads various kinds of data read out from the HDD 170 in an area allocated to the anomaly detection process 180a in a storage area of the RAM 180, and executes various kinds of processing using the various kinds of loaded data. For example, examples of the processing to be executed by the anomaly detection process 180a include the processing illustrated in FIG. 16. Note that all the processing units indicated in the first embodiment described above do not necessarily operate in the CPU 150, and it is sufficient if only a processing unit corresponding to processing to be executed is virtually implemented.

Note that the anomaly detection program 170a described above does not necessarily stored in the HDD 170 or the ROM 160 from the beginning. For example, each program may be stored in a “portable physical medium” such as a flexible disk, which is what is called an FD, a compact disc read only memory (CD-ROM), a digital versatile disk (DVD), a magneto-optical disk, or an integrated circuit (IC) card to be inserted into the computer 100. Then, the computer 100 may also obtain and execute each program from those portable physical media. Furthermore, each program may also be stored in another computer, server apparatus, or the like connected to the computer 100 via a public line, the Internet, a LAN, a wide area network (WAN), or the like, and the computer 100 may obtain each program from them to execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An anomaly detection method for a computer to execute a process comprising:
obtaining a plurality of waveform data detected by a plurality of sensors arranged on a monitoring target;
specifying a plurality of target waveform data from among the plurality of waveform data based on a correlation of a shape of the obtained plurality of waveform data;
combining the plurality of target waveform data into combined waveform data;
clustering the combined waveform data by dividing into clusters for a time unit; and
detecting an anomaly of the monitoring target based on a size of each of the clusters.

2. The anomaly detection method according to claim 1, wherein the process further comprising:
acquiring a correlation coefficient between first waveform data of the plurality of waveform data and each of the plurality of waveform data other than the first waveform data, wherein
the specifying includes specifying second waveform data whose correlation coefficient is equal to or higher than a threshold value among the plurality of waveform data as the target waveform data.

3. The anomaly detection method according to claim 2, wherein the process further comprising:
correcting the second waveform data based on a weight of a linear regression model that uses the first waveform data as a response variable and uses the second waveform data as an explanatory variable, wherein
the combining includes combining the corrected second waveform data into the combined waveform data.

4. The anomaly detection method according to claim 1, wherein
the detecting includes detecting an element included in a cluster with a number of elements less than a threshold value as an anomaly point among the clusters.

5. The anomaly detection method according to claim 1, wherein
the detecting includes detecting an element included in a certain number of clusters in order from a cluster with a smallest number of elements as an anomaly point among the clusters.

6. The anomaly detection method according to claim 1, wherein
the plurality of sensors is arranged on a mobile object.

7. The anomaly detection method according to claim 6, wherein
the mobile object is a ship, a vehicle, or a person.

8. A non-transitory computer-readable storage medium storing an anomaly detection program that causes at least one computer to execute a process, the process comprising:
obtaining a plurality of waveform data detected by a plurality of sensors arranged on a monitoring target;
specifying a plurality of target waveform data from among the plurality of waveform data based on a correlation of a shape of the obtained plurality of waveform data;
combining the plurality of target waveform data into combined waveform data;
clustering the combined waveform data by dividing into clusters for a time unit; and
detecting an anomaly of the monitoring target based on a size of each of the clusters.

9. The non-transitory computer-readable storage medium according to claim 8, wherein the process further comprising:
acquiring a correlation coefficient between first waveform data of the plurality of waveform data and each of the plurality of waveform data other than the first waveform data, wherein
the specifying includes specifying second waveform data whose correlation coefficient is equal to or higher than a threshold value among the plurality of waveform data as the target waveform data.

10. The non-transitory computer-readable storage medium according to claim 9, wherein the process further comprising:
correcting the second waveform data based on a weight of a linear regression model that uses the first waveform data as a response variable and uses the second waveform data as an explanatory variable, wherein
the combining includes combining the corrected second waveform data into the combined waveform data.

11. The non-transitory computer-readable storage medium according to claim 8, wherein
the detecting includes detecting an element included in a cluster with a number of elements less than a threshold value as an anomaly point among the clusters.

12. The non-transitory computer-readable storage medium according to claim 8, wherein
the detecting includes detecting an element included in a certain number of clusters in order from a cluster with a smallest number of elements as an anomaly point among the clusters.

13. The non-transitory computer-readable storage medium according to claim 8, wherein
the plurality of sensors is arranged on a mobile object.

14. The non-transitory computer-readable storage medium according to claim 13, wherein
the mobile object is a ship, a vehicle, or a person.

15. An anomaly detection device comprising:
one or more memories; and
one or more processors coupled to the one or more memories and the one or more processors configured to:
obtain a plurality of waveform data detected by a plurality of sensors arranged on a monitoring target,
specify a plurality of target waveform data from among the plurality of waveform data based on a correlation of a shape of the obtained plurality of waveform data,
combine the plurality of target waveform data into combined waveform data,
cluster the combined waveform data by dividing into clusters for a time unit, and
detect an anomaly of the monitoring target based on a size of each of the clusters.
